(19) United States
(12) Patent Application Publication
(10) Pub. No.: US 2016/0176384 A1
(43) Pub. Date: Jun. 23, 2016

(54) SENSOR CLEANING SYSTEM

(71) Applicant: Continental Automotive Systems, Inc., Auburn Hills, MI (US)

(72) Inventors: Matthew Joseph Dissette, Washington Township, MI (US); Michael J. Zaitz, Royal Oak, MI (US); Nicholas Lee Mawhinney, Linden, MI (US)

(21) Appl. No.: 14/577,271

(22) Filed: Dec. 19, 2014

(51) Int. Cl. B60S 1/52; B60S 1/02

(52) U.S. Cl. CPC B60S 1/52; B60S 1/023

(57) ABSTRACT

A method of cleaning a radar sensor for a vehicle comprises monitoring a signal output from an external radar sensor for the vehicle with an electronic control unit and comparing the signal output to a signal quality threshold. Debris is cleaned from a protective screen located between the sensor and the external environment of the vehicle when the signal output is below the quality threshold. Cleaning the debris from the protective screen is performed by one of heating the protective screen by activating a heating element located proximate to the protective screen or spraying a fluid from a nozzle located in a bezel surrounding the protective screen and proximate to the protective screen over the exterior surface of the screen.

### TECHNICAL FIELD

The present disclosure relates to automotive vehicles and more particularly to sensors for automotive vehicles.

### BACKGROUND

During use automotive vehicles collect dust and debris that may obscure the operator's point of view. In colder climates ice may also form on these surfaces. Automotive vehicles are typically equipped with windshield washer systems and the heating system typically includes defrosting options. Additionally externally mounted cameras, such as back up assist and parking assist, frequently become obscured as a result of dirt and debris. Therefore, the washing and heating systems have been expanded to also provide fluid and/or defrosting to other locations on the vehicle such as rear windows, headlamps, and externally mounted cameras.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of cleaning a sensor for a vehicle comprises monitoring a signal output from an external sensor for the vehicle with an electronic control unit and comparing the signal output to a signal quality threshold. Debris is cleaned from a protective screen located between the sensor and the external environment of the vehicle when the signal output is below the quality threshold. Cleaning the debris from the protective screen is performed by one of heating the protective screen by activating a heating element located proximate to the protective screen or spraying a fluid from a nozzle located in a bezel surrounding the protective screen and proximate to the protective screen over the exterior surface of the screen.

A sensor cleaning assembly for a vehicle comprises a sensor mountable to a vehicle component, a protective screen located between the sensor and an exterior environment of the vehicle, a bezel surrounding the protective screen, and a defrost element located proximate to the protective screen to apply heat to the protective screen, such that debris is removed from the protective screen.

A sensor cleaning assembly for a vehicle comprises a sensor mountable to a vehicle component, a protective screen located between the sensor and an exterior environment of the vehicle, a bezel surrounding the protective screen, and a nozzle located proximate to the sensor. The nozzle includes a plurality of holes formed in the bezel and arranged to direct a fluid over the surface of the protective screen.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle having a cleaning and defrosting system of the present invention;

FIG. 2 is a schematic exterior perspective illustration of a sensor assembly for the cleaning system of FIG. 1;

FIG. 3 is a schematic perspective illustration of a first embodiment of the sensor cleaning system of FIGS. 1-2;

FIG. 3A is a schematic front view illustration of the first embodiment of the sensor cleaning system of FIGS. 1-3;

FIG. 3B is a schematic front view illustration of the first embodiment of the sensor cleaning system of FIGS. 1-3A, showing section line B-B;

FIG. 3C is a schematic cross-sectional illustration of the first embodiment of the sensor cleaning system of FIGS. 1-3B, along section line B-B;

FIG. 3D is an enlarged schematic cross-sectional illustration of the first embodiment of the sensor cleaning system, illustrating detail X of FIG. 3B;

FIG. 4 is a schematic perspective illustration of a second embodiment of the sensor cleaning system of FIGS. 1-2;

FIG. 4A is a schematic front view illustration of the second embodiment of the sensor cleaning system of FIGS. 1-2 and 4;

FIG. 5 is a schematic perspective illustration of a third embodiment of the sensor cleaning system of FIGS. 1-2;

FIG. 5A is a schematic front view illustration of the third embodiment of the sensor cleaning system of FIGS. 1-2 and 5, showing section line A-A;

FIG. 5B is a schematic cross-sectional illustration of the third embodiment of the sensor cleaning system of FIGS. 1-2 and 5-5A, along section line A-A; and

FIG. 5C is an enlarged schematic front view illustration of the third embodiment of the sensor cleaning system of FIGS. 1-2 and 5-5B.

### DETAILED DESCRIPTION

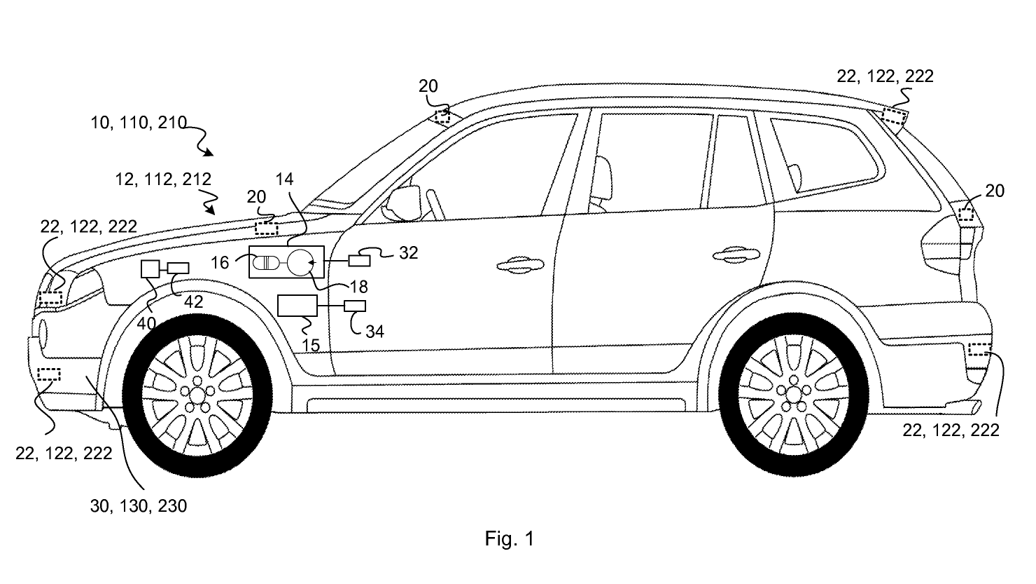

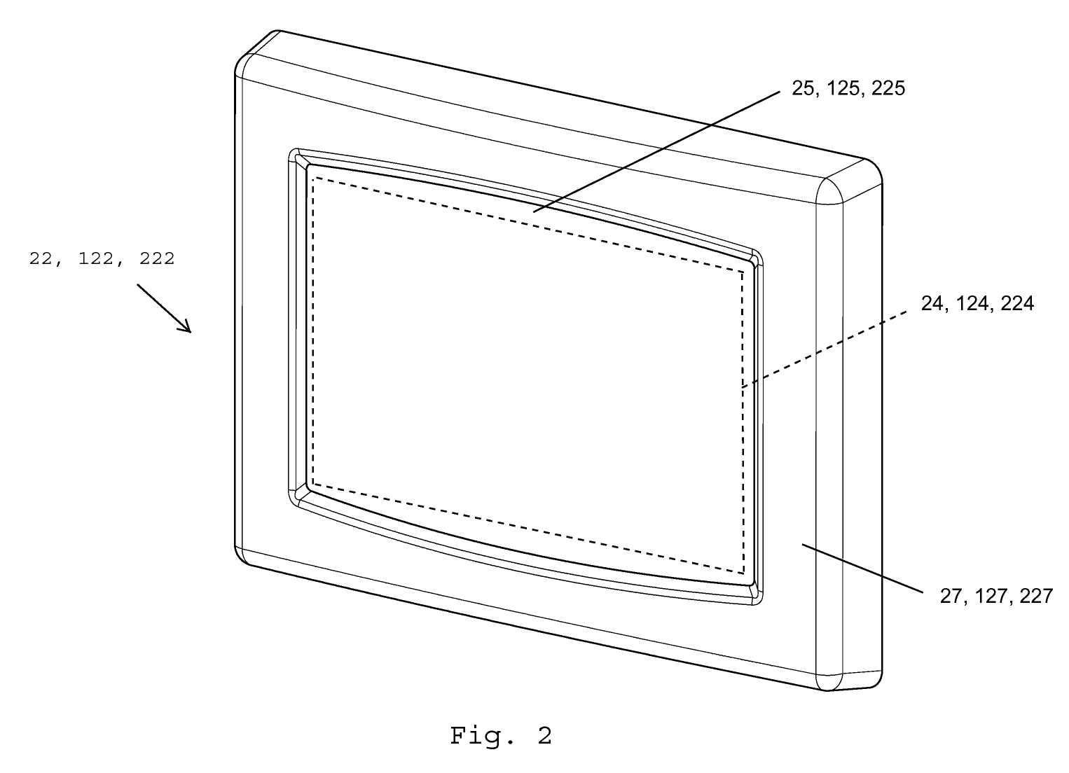

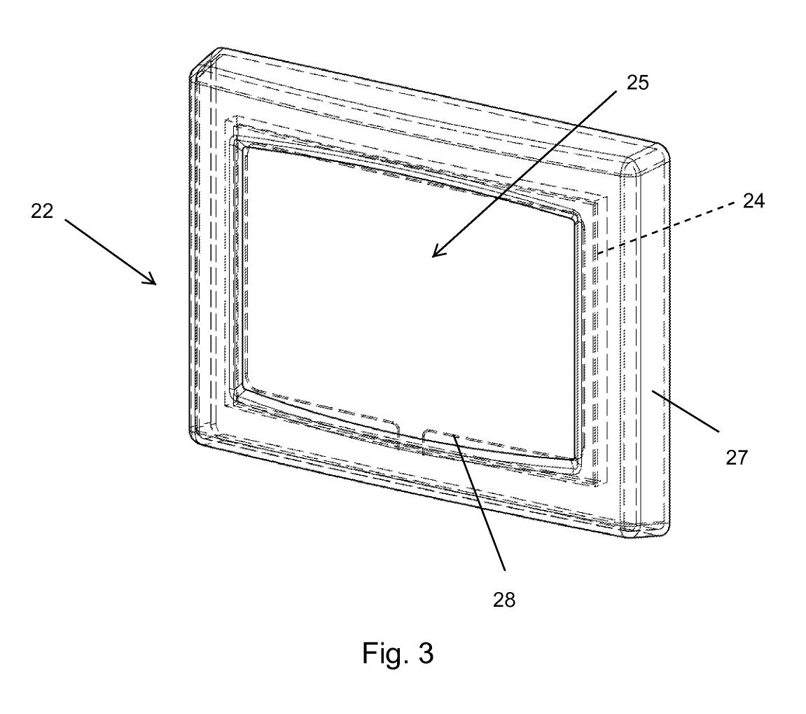

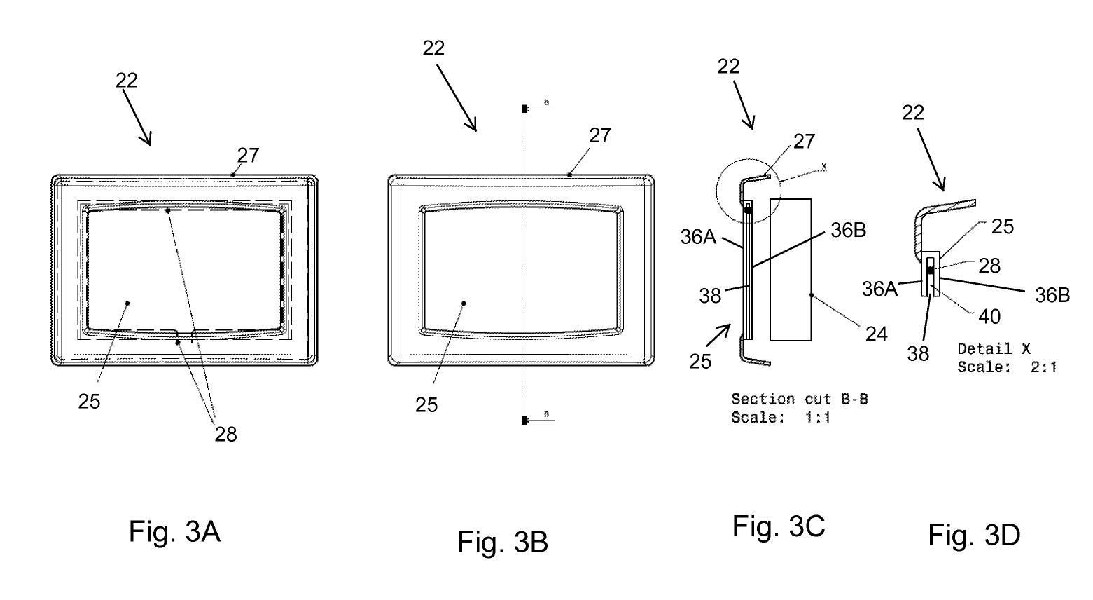

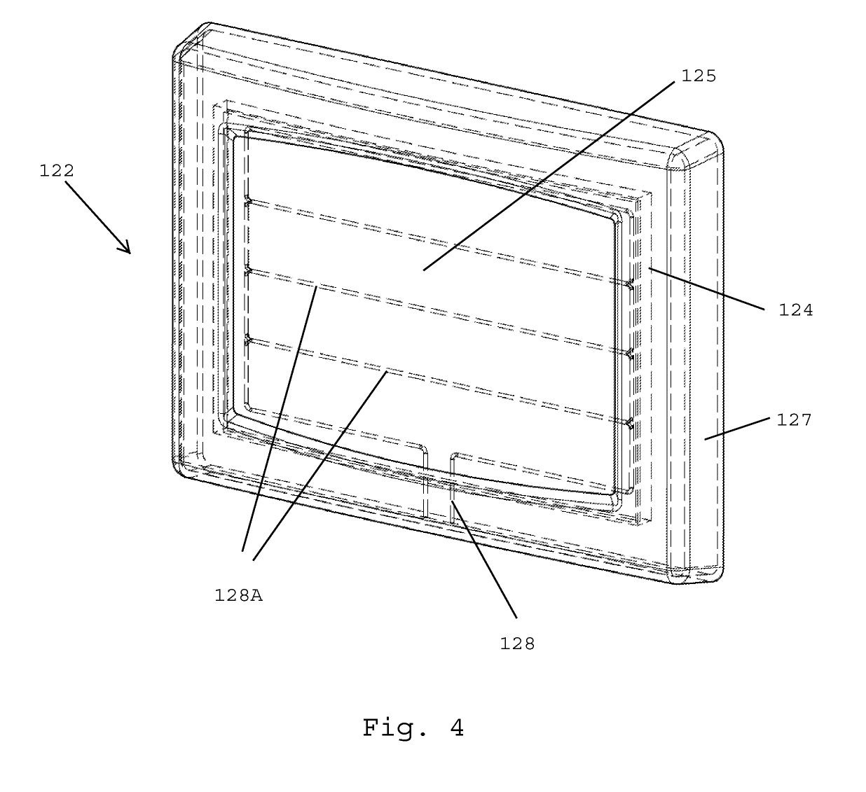

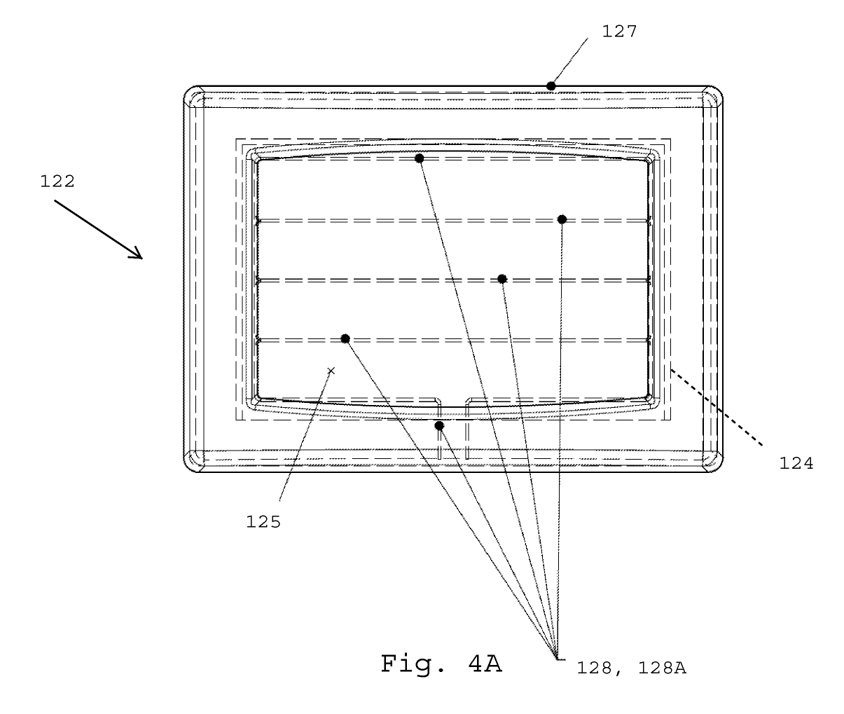

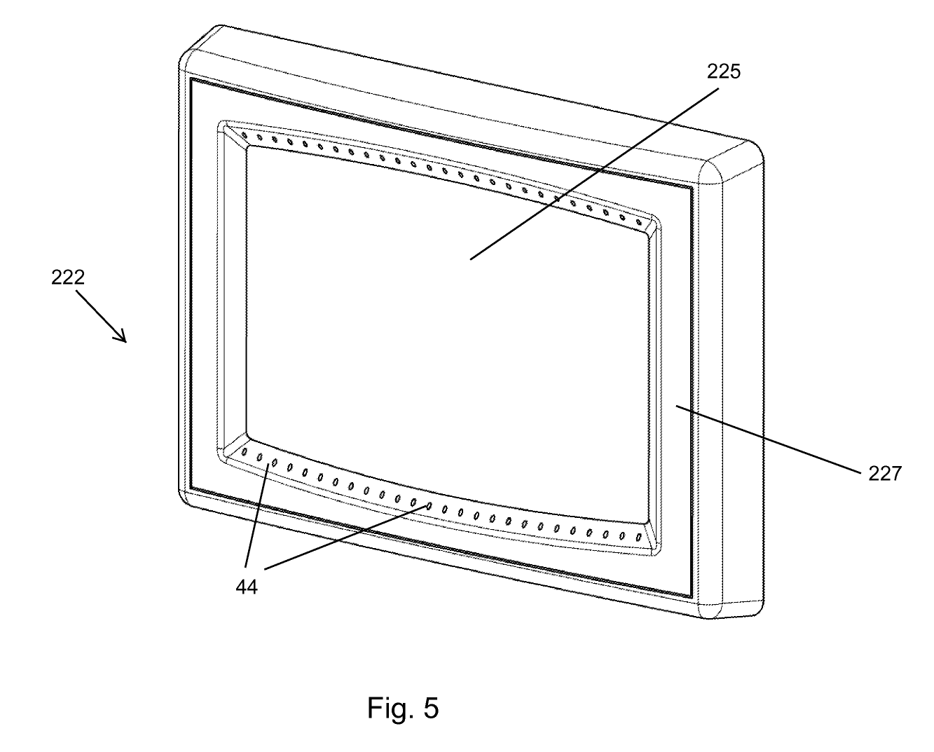

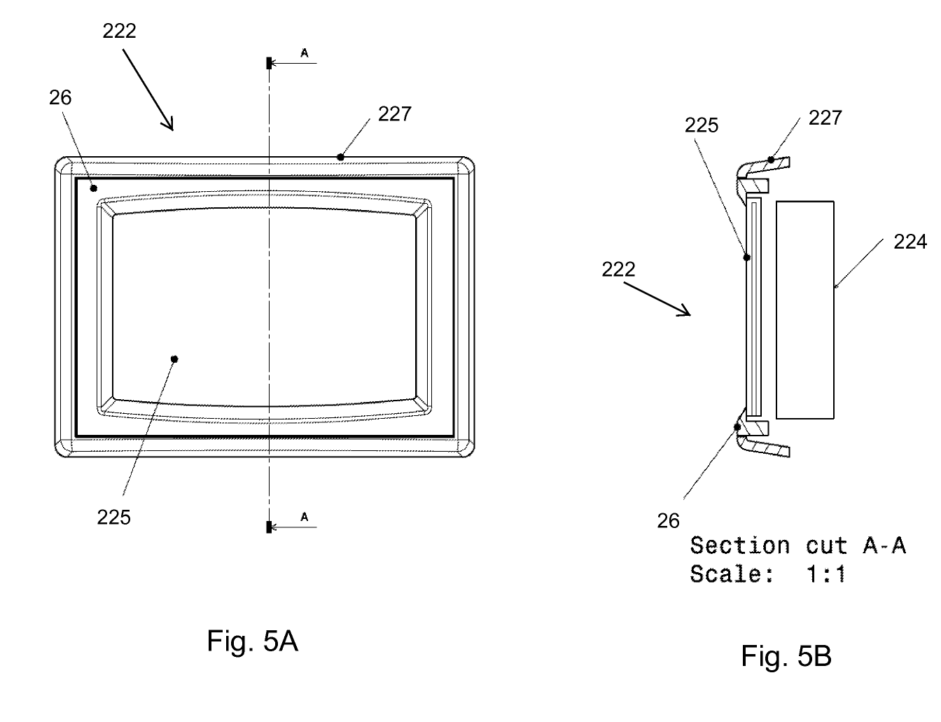

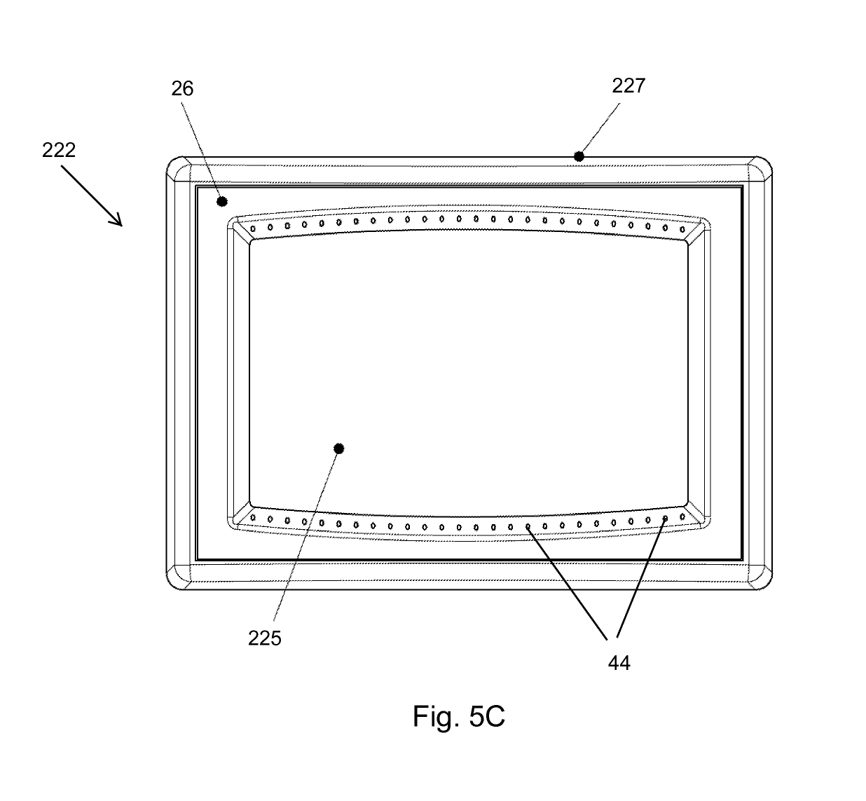

The following description is merely exemplary in nature and is in no way intended to limit the disclosure, its application, or uses. For purposes of clarity, the same reference numbers will be used in the drawings to identify similar elements. FIGS. 1-7 illustrate a vehicle 10 having a sensor cleaning system 12, 112, 212. The sensor cleaning system 12 includes at least a sensor assembly 22, 122, 222. The sensor assembly 22, 122, 222 includes a sensor unit 24, 124, 224, a protective screen 25, 125, 225, and a trim element 27, 127, 227 for securing the protective screen to the vehicle 10. The protective screen 125 may have a convex shape to aid in preventing debris from accumulating on the screen 125.

The sensor assembly 22, 122, 222 may also include a nozzle 26 and/or a defrost element 28, 128 as described in further detail below. The nozzle 26 and the defrost element 28, 128 are located proximate to the sensor 24, 124, 224. The nozzle 26 and the defrost element 28, 128 may or may not be directly secured to the sensor 24, 124, 224. The sensor assembly 22, 122, 222 is mounted to a vehicle component 30, 130, 230 via the trim element 27, 127, 227. The vehicle component 30, 130, 230 may be a body panel, a bumper, a grille, etc. for the vehicle 10. The sensor assembly 22, 122, 222 is mounted to the vehicle component 30, 130, 230 in a manner that allows the sensor 24, 124, 224 to provide data from the external environment around the vehicle 10. The sensor 24, 124, 224 may be any type of sensor which mounted externally to the vehicle 10, such as a radar sensor which may be used for forward collision alert, adaptive cruise control, etc. A housing (not shown) may enclose all or some of the elements for the sensor assembly 22, 122, 222 to easier mounting, packaging and provide further protection from the external vehicle environment.

Additionally, the sensor cleaning system 12, 112, 212 may be partially connected with a washing system 14 and or/defrost system 15 as described in further detail blow. The washing system 14 includes a fluid reservoir 16 and a pump 18. Fluid lines (not shown) connect the pump 18 to window washer nozzles 20 and may connect to a sensor assembly 22. A control 32 for the washing system 14 may be mounted in the passenger compartment of the vehicle 10. The vehicle 10 also has a defrost system 15 having defrost controls 34 location within the passenger compartment for the vehicle 10. The defrost system 15 may be connected (not shown) to the HVAC system or various electrical components (not shown), such as wires embedded in the rear window, to provide defrost for the vehicle 10.

Debris, such as dirt or ice may settle on the vehicle 10 during normal usage. The debris may block or obscure exterior mounted sensors 24, 124, 224 and may cause signals emitted from externally mounted sensors 24, 124, 224 to dissipate reducing the accuracy and distance over which the sensors 24, 124, 224 operate. Therefore, the sensor cleaning system 12, 112, 212 provides an arrangement and method for cleaning the sensor 24, 124, 224 in various vehicle 10 environments. The sensor assembly 22, 122, 222 may therefore be provided as a module for assembly into the vehicle 10. The sensor cleaning system 12, 112, 212 minimizes the reduction in effectiveness and efficiency of the sensor 24, 124, 224 by use of the clean and defrost feature. Maintaining effectiveness and efficiency of the sensor 24, 124, 224 provides a key improvement in safety for the vehicle 10.

A method of cleaning a sensor assembly 22, 122, 222 for a vehicle 10, 110, 210 comprises monitoring a signal output from an external sensor 24, 124, 224 for the vehicle 10, 110, 210 with an electronic control unit 42 and comparing the signal output to a signal quality threshold. Debris is cleaned from a protective screen 25, 125, 225 located between the sensor 24, 124, 224 and the external environment of the vehicle 10, 110, 210 when the signal output is below the quality threshold. Cleaning the debris from the protective screen is 25, 125, 225 performed by one of heating the protective screen 25, 125, 225 by activating a heating element 28, 128 located proximate to the protective screen 25, 125, 225 or spraying a fluid from a nozzle 26 located in a bezel 27, 127, 227 surrounding the protective screen 25, 125, 225 and proximate to the protective screen 25, 125, 225 over the exterior surface of the screen 25, 125, 225.

With respect to FIGS. 1-3D, a first embodiment of the sensor cleaning system 12 is described. The protective screen 25 comprises two layers 36A and 36B of material, e.g. glass, extending generally parallel and spaced from one another to define a cavity 38 therebetween. The cavity 38 is at least partially filled with a heat conductive gel 40. Additionally, heat element 28 is disposed within the cavity 38. In the embodiment shown, the heat element is positioned to follow a perimeter of the cavity 38. In another embodiment, the heat element 28 may be a plurality of wires extending generally parallel and spaced from one another across the cavity 38.

Debris, such as dirt or ice may settle on the vehicle 10 during normal usage. The debris may block or obscure the sensor 24 and may cause signals emitted from externally mounted sensors 24 to dissipate reducing the accuracy and distance over which the sensors 24 operate. The sensor cleaning system 12 may receive an activation signal to heat the heating element 28. The heat from the heating element 28 increases the temperature of the heat conductive gel 40 which raises the temperature on the protective screen 25 thereby, melting slush, ice and/or snow located on the exterior surface of the protective screen 25.

A vehicle system 40, which uses the sensor unit 24 may analyze the sensor signal and recognize degradation in signal quality. The vehicle system 40 may then send an activation signal to the sensor cleaning system 12. The vehicle system may be a forward collision alert, rear collision alert, etc. and an ECU 42 for the vehicle system 40 analyzes the signal quality to detected degradation.

Therefore, a method of cleaning the sensor assembly 22 for the vehicle 10 comprises monitoring a signal output from the external sensor 24 with an electronic control unit 42 and comparing the signal output to a signal quality threshold. Debris is cleaned from the protective screen 25, when the signal output is below the quality threshold. Cleaning the debris from the protective screen 25 is performed by heating the protective screen 25, by activating the heating element 28 located proximate to the protective screen 25. The heating element is located between two layers 36A, 36B of the protective screen 25, spaced apart and parallel to one another to define a cavity 38; and wherein activating the heating element applies heat to a heat conductive gel 40 is located within the cavity 38, such that the protective screen 25 is heated. The heating element 28 is a wire extending around a perimeter of the cavity 38 defined by the layers 36A, 36B of the protective screen 25.

Alternatively, the sensor cleaning system may be connected to a defrost system 15 for the vehicle. The heating element 28 may be activated at the same time the vehicle 10 defrost system 15 is activated.

With respect to FIGS. 1-2, FIG. 4 and FIG. 4A, a second embodiment of the sensor cleaning system 112 is described. A heat element 128 is positioned to follow a perimeter of the protective screen 125. Additionally, the heat element 128 may also include element strands 128A which extend in parallel spaced arrangement across the protective screen 125. The element strands 128A may be sized, and positioned in such a manner that they do not interfere with the sensor 24 ability to sensor the external environment.

Debris, such as dirt or ice may settle on the vehicle 110 during normal usage. The debris may block or obscure the sensor 124 and may cause signals emitted from externally mounted sensors 124 to dissipate reducing the accuracy and distance over which the sensors 214 operate. The sensor cleaning system 112 may receive an activation signal to heat the heating element 128 and strands 128A. The heat from the heating element 128 and 128A increases the temperature of the protective screen 125 thereby, melting slush, ice and/or snow located on the exterior surface of the protective screen 125.

A vehicle system 40, which uses the sensor unit 124 may analyze the sensor signal and recognize degradation in signal quality. The vehicle system 40 may then send an activation signal to the sensor cleaning system 112. The vehicle system may be a forward collision alert, rear collision alert, etc. and an ECU 42 for the vehicle system 40 analyzes the signal quality to detected degradation.

Therefore, a method of cleaning the sensor assembly 122 for the vehicle 110 comprises monitoring a signal output from the external sensor 124 with an electronic control unit 42 and comparing the signal output to a signal quality threshold. Debris is cleaned from the protective screen 125, when the signal output is below the quality threshold. Cleaning the debris from the protective screen 125 is performed by heating the protective screen 125, by activating the heating element 128 located proximate to the protective screen 125. The heating element 128 is a wire extending around a perimeter of the protective screen 25 and a plurality of parallel strands 128A extending across the surface of the screen 125.

Alternatively, the sensor cleaning system may be connected to a defrost system 15 for the vehicle. The heating element 128, 128A may be activated at the same time the vehicle 110 defrost system 15 is activated.

With respect to FIGS. 1-2, and FIG. 5-5C, a third embodiment of the sensor cleaning system 212 is described. A nozzle 26 is formed around a perimeter around the protective screen 225. The nozzle 26 includes a plurality of holes 44 defined in a bezel 227. The nozzle 26 is connected (not shown) to a fluid reservoir 16, such as a fluid reservoir for a washer system, or an independent fluid reservoir for the sensor cleaning system 212. Separate front and rear reservoirs may be used for sensors 24 located at the front or rear of the vehicle 210. The nozzle 26 can be used with fluid that is under pressure, as with a pump, such as 18. Alternatively, the fluid to the nozzle 26 may be gravity fed by opening a valve associated with the nozzle 26.

Debris, such as dirt or ice may settle on the vehicle 210 during normal usage. The debris may block or obscure the sensor 224 and may cause signals emitted from externally mounted sensors 224 to dissipate reducing the accuracy and distance over which the sensors 224 operate. The sensor cleaning system 212 may receive an activation signal to pump or release fluid from a fluid reservoir to the nozzle 26. The fluid flows from the holes 44 in the bezel 227 the protective screen 225 thereby, melting slush, ice and/or snow located on the exterior surface of the protective screen 225. The fluid may be heated, or may simply above freezing temperature to remove the debris.

A vehicle system 40, which uses the sensor unit 224 may analyze the sensor signal and recognize degradation in signal quality. The vehicle system 40 may then send an activation signal to the sensor cleaning system 212. The vehicle system may be a forward collision alert, rear collision alert, etc. and an ECU 42 for the vehicle system 40 analyzes the signal quality to detected degradation.

A method of cleaning a sensor assembly 222 for a vehicle 1210 comprises monitoring a signal output from an external sensor 224 for the vehicle 210 with an electronic control unit 42 and comparing the signal output to a signal quality threshold. Debris is cleaned from a protective screen 225 located between the sensor 224 and the external environment of the vehicle 210 when the signal output is below the quality threshold. Cleaning the debris from the protective screen is 225 performed by on spraying a fluid from a nozzle 26 located on a bezel 227 surrounding the protective screen 225 over the exterior surface of the screen 225.

Alternatively, the sensor cleaning system may be connected to a washer system 14 for the vehicle 210. The nozzle 26 for the sensor cleaning system 212 may be activated at the same time the vehicle 210 washer system 14 is activated. For example, when the washing system 14 is activated with the control device 32 fluid is sent from the reservoir 16 to the window washer nozzles 20 and the at least one sensor assembly 222. The pump 18 pressurizes the fluid to create a pressure differential between the washer system 14 and atmospheric pressure around the vehicle 10. The pressure differential is sufficient to disperse the fluid through the nozzle 26 and spray or wash over an exterior surface of the protective 225 for the sensor 224. The nozzle 26 may be any fluid dispersion device such as a jet nozzle, fan nozzle, other opening or aperture, etc. The angle shape, size and flow rate of the fluid may be determined by the vehicle configuration, the type of sensor assembly 222 and the particular location of the sensor assembly 222 on the vehicle 10.

The sensor assemblies 222 located at the rear of the vehicle 210 may be fluidly connected (not shown) to the same reservoir as a rear window washer nozzle 20. Likewise a sensor assemblies 222 located at the front of the vehicle 210 may be fluidly connected (not shown) to the same conduit as a front window washer nozzle 20. Therefore, if the forward and rear window washer nozzles 20 operate separately from one another the associated sensor assemblies 222 will operate at the same time as the respective window washer nozzle 20.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A method of cleaning a sensor for a vehicle comprising:
monitoring a signal output from an external sensor for the vehicle with an electronic control unit;
comparing the signal output to a signal quality threshold;
cleaning debris from a protective screen located between the sensor and the external environment of the vehicle when the signal output is below the quality threshold; and
wherein cleaning the debris from the protective screen is performed by one of;
heating the protective screen by activating a heating element located proximate to the protective screen; and
spraying a fluid from a nozzle located in a bezel surrounding the protective screen and proximate to the protective screen over the exterior surface of the screen.

2. The method of claim 1, wherein the heating element further is located between two layers of the protective screen, spaced apart and parallel to one another to define a cavity; and wherein activating the heating element applies heat to a heat conductive gel is located within the cavity, such that the protective screen is heated.

3. The method of claim 2, wherein the heating element is a wire extending around a perimeter of the cavity defined by the layers of the protective screen.

4. The method of claim 1, wherein the heating element is a wire extending around a perimeter of the protective screen and a plurality of parallel strands extending across the protective screen.

5. The method of claim 1, wherein the nozzle is located proximate to the sensor and includes a plurality of holes formed in the bezel and arranged to direct a fluid over the surface of the protective screen

6. The method of claim 1, wherein the fluid is stored in a reservoir for a washer system of the vehicle.

7. The method of claim 1, wherein cleaning the debris from the protective screen is controlled by one of a defrost control for a defrost system and a washer control for a washer system.

8. The method of claim 1, wherein the sensor is a radar sensor.

9. A sensor cleaning assembly for a vehicle comprising:
a sensor mountable to a vehicle component;
a protective screen located between the sensor and an exterior environment of the vehicle;
a bezel surrounding the protective screen; and
a defrost element located proximate to the protective screen to apply heat to the protective screen such that debris is removed from the protective screen.

10. The sensor cleaning assembly of claim 9, wherein a signal output from the sensor is monitored by an electronic control unit, and wherein the heating element is activated when the signal output from the sensor is below a predetermined threshold.

11. The sensor cleaning assembly claim 9, wherein the protective screen comprises two layers spaced apart and parallel to one another to define a cavity; wherein a heat conductive gel is located within the cavity, and wherein the defrost element is located within the cavity to apply heat to the heat conductive gel, such that the protective screen is heated.

12. The sensor cleaning assembly of claim 11, wherein the defrost element is one of a wire extending around a perimeter of the cavity defined by the layers of the protective screen.

13. The sensor cleaning assembly of claim 9, wherein the defrost element is a wire extending around a perimeter of the protective screen and a plurality of parallel strands extending across the protective screen.

14. The sensor cleaning assembly of claim 9, wherein the vehicle component is one of a body panel, a bumper, and a grille.

15. The sensor cleaning assembly of claim 9, wherein the defrost element is controlled by a defrost control for the defrost system.

16. The sensor cleaning assembly of claim 9, wherein the sensor is a radar sensor.

17. A sensor cleaning assembly for a vehicle comprising:
a sensor mountable to a vehicle component;
a protective screen located between the sensor and an exterior environment of the vehicle;
a bezel surrounding the protective screen; and
a nozzle located proximate to the sensor, wherein the nozzle includes a plurality of holes formed in the bezel and arranged to direct a fluid over the surface of the protective screen.

18. The sensor cleaning assembly of claim 17, wherein a signal output from the sensor is monitored by an electronic control unit, and wherein the sensor cleaning assembly is activated to direct fluid over the protective screen when the signal output from the sensor is below a predetermined threshold.

19. The sensor cleaning assembly of claim 17, wherein the fluid flow over the protective screen is controlled by a washer control for a washer system of the vehicle.

20. The sensor cleaning assembly of claim 17, wherein the fluid is stored in a reservoir for a washer system of the vehicle.

21. The sensor cleaning assembly of claim 17, wherein the vehicle component is one of a body panel, a bumper, and a grille.

22. The sensor cleaning assembly of claim 17, wherein the sensor is a radar sensor.
